(19) United States
(12) Patent Application Publication
(10) Pub. No.: US 2015/0315532 A1
(43) Pub. Date: Nov. 5, 2015

(54) CONTAINER WITH CLOSURE DEVICE

(71) Applicant: Henkel AG & Co. KGaA, Duesseldorf (DE)

(72) Inventors: Ingmar Bergbohm, Olpe (DE); Ralph Butter-Jentsch, Langenfeld (DE)

(21) Appl. No.: 14/798,643

(22) Filed: Jul. 14, 2015

Related U.S. Application Data
(63) Continuation of application No. PCT/EP2014/050070, filed on Jan. 6, 2014.

(30) Foreign Application Priority Data
Jan. 16, 2013 (DE) 10 2013 200 532.6

(51) Int. Cl. C11D 17/04; B65D 43/22; B65D 43/16

(52) U.S. Cl. CPC C11D 17/04; B65D 43/16; B65D 43/22

(57) ABSTRACT

A container has closure device (10) with a frame (1), which defines an opening (9), and with a lid (2), which covers over the opening (9) and has at least two closing means (4, 5). The lid is coupled to the frame (1) such that it can be pivoted between an open position and a closed position via a pivot axis (3). First and second spaced-apart closing means (4, 5) of the lid (2), said closing means each being formed from a lid portion and an associated frame portion, can be opened by a force being applied directly to the associated frame portion (4.1) or by a force being applied directly to the associated lid portion (4.2).

### FIELD OF THE INVENTION

The present invention generally relates to a container with a closure device, and more particularly relates to a container for detergents and cleaning agents. The closure device has a frame and a lid with at least two closing means.

### BACKGROUND OF THE INVENTION

It is customary today to use active ingredients for example from the group of textile detergents, dishwashing agents, pharmaceuticals, body care agents, agricultural aids, construction materials, dyes, adhesives or foodstuffs in a flowable or pourable form or as predosed amounts which are stored as predosed units in a container, for example. Plastic containers that may be transparent, among other things, are known in the field of stocking commercial quantities of these active ingredients.

These closure devices often have a frame in conjunction with the respective container, this frame defining an opening for removing active ingredient from the container, wherein the opening can be closed by a lid. The lid is typically held in a closed position by one or more closing means.

It is desirable here for one or more closing means to hold the lid in the closed position on the frame even if other forces are acting on the frame or on the lid. These forces can elastically deform the closure device and, in the worst case, may cause the closure device to open inadvertently. Such forces may occur during shipping, for example, or as a result of improper handling, such as a child attempting to open the lid in an unintended manner. To this extent, there is a current demand for a safe design of the closed position of the closure device, on the one hand, while on the other hand, not making the intended opening of the closure device unnecessarily difficult in the case of generic closure devices in combination with containers for contents that are hazardous to health in particular. For this purpose, the closing means must be simple to operate, among other things, in order to be able to open the lid in the intended manner.

EP 1 088 769 A1 (Owens-Illinois Closure) discloses a container which has a closing means on opposite sides of its frame. To open the container in the intended manner, the user must use two hands, with each hand holding a closing means in the open position, while the lid is being tilted up. The first and second closing means may be opened by applying a force to a respective frame section.

EP 0 861 793 A1 discloses a package holding a lid in the closed position by a closing means with a hook. To open the lid, it must be deformed by applying a force to the lid, thereby freeing the hook from its latching position.

WO 2011/094685 A2 discloses a package for detergent units. To open the lid of the package, the closing means must be opened by applying a force to a bracket arranged in a lid section and opening it. The closing means and the lid need not be opened at the same time. The closing means holds the lid in a closed position only when the bracket is returned to the closed position by pressing on a frame section.

The closure devices mentioned above for holding a container in a closed position are tedious to operate to this extent or may even be too easily opened unintentionally.

The object of the invention is therefore to provide a generic closure device that is capable of holding a lid with a frame securely in a closed position but can still be opened it in a user-friendly manner

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Container for detergents and cleaning agents comprising a closure device (10), the closure device (10) comprising: a frame (1), which defines an opening (9), and a lid (2), which covers the opening (9) and is coupled to the frame so as to be pivotable about a pivot axis (3), which is arranged on one side of the frame (1), to change from a closed position, in which the lid (2) closes the opening (9), into an open position, in which the lid (2) is at a distance from the frame (1) and thus exposes the opening (9); at least one first and one second closing means (4, 5), each formed from a lid section and a respective frame section, to hold the lid in the closed position on the frame (1), characterized in that: the first closing means (4) can be opened by direct application of force to the respective frame section; the second closing means (5) can be opened by direct application of force to the respective lid section; and the first and the second closing means (4, 5) are spaced a distance apart from one another.

### BRIEF DESCRIPTION OF THE DRAWINGS

The present invention will hereinafter be described in conjunction with the following drawing figures, wherein like numerals denote like elements, and

FIG. 1, a closure device according to the invention with a lid and a frame having a first and a second closing means in a perspective basic diagram;

FIG. 2, a second closing means of a closure device according to the invention in a sectional diagram;

FIG. 3, a first closing means of a closure device according to the invention in a sectional diagram; and

FIG. 4, a section of the closure device with a lid and a frame in a region without closing means in a sectional diagram.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The closure device according to the invention has a frame, which defines an opening, and has a respective lid, wherein the lid is connected to the frame on one side of the frame so as to be pivoted via a pivot axis, in order to be pivoted between a closed position and an open position. The lid thus closes the corresponding opening in the frame when changing to the closed position. At least one first closing means and one second closing means are provided on the closure device, each comprising a lid section and a frame section. The closing means hold the lid in the closed position. The closure device can be opened properly only when all the closing means are in the open position, wherein the first closing means can be opened by direct application of force to the respective frame section, and the second closing means can be opened by direct application of force to the respective lid section. The first and the second closing means are also arranged a distance apart from one another on the closure device. In particular the closing means are designed and arranged in such a way that a simultaneous activation of two closing means is usually possible only by using both of the user's hands. The closure device may fundamentally also comprise additional closing means in addition to the first and second closing means, preferably being embodied either like the first or the second closing means. Direct application of force to the first, second or additional closing means is independent of any other. It follows from this that the closure device cannot easily be opened accidentally by children, for example. A clear distinction is to be made here between opening the closure device as a whole and opening one single closing means. Proper opening of the entire closure device, so that the opening is exposed, can be achieved only if all the individual closing means have been transferred to an open, i.e., unlocked, position.

In a preferred embodiment, the closing means are the first and second closing means. Providing two closing means is a simple solution, which nevertheless offers enough closing reliability for most applications. In another embodiment, the closing means include the first and second closing means plus an additional closing means. A higher level of closing reliability of the entire closure device is achieved by providing a third closing means. Additional independent closing means can further increase the closing reliability.

In the closed position of the lid with respect to the frame, a closing means can be brought into an unlocked position of the closing means by application of force to a lid section or frame section assigned to the closing means. The closing means can thus be opened only with a targeted application of force to very specific locations. This effectively prevents unintentional opening of individual closing means or even the entire closure device.

In a preferred embodiment, to open the closure device with two closing means, the user presses, preferably with the left thumb, on the frame section assigned to the first closing means, while at the same time pressing with the right thumb on the lid section assigned to the second closing means. The pivoting movement of the lid to open the lid from the closed position is then carried out by the right hand at the same time. The other fingers of the two hands can secure the closure device in its position. In a manner similar to that, in the reverse arrangement of the first and second closing means, the user's fingers are positioned the other way around, and the pivoting movement of the lid is then carried out with the left hand.

In another embodiment with three closing means, the second closing means is arranged between the first and third closing means. The third closing means is preferably designed like the first closing means. In this embodiment, the closure device is opened in the prefened manner, in that the user, by using one finger on the left/right hand each, presses on the respective frame sections of the outermost (first and third) closing means. For this purpose, the user must press simultaneously with the right/left thumbs on the lid section assigned to the second closing means, wherein the right/left hand also carries out the pivoting movement of the lid to open the lid. Other fingers of the right/left hand hold the device securely at the same time. The right/left hand is preferably above the left/right hand to facilitate the opening of the device by a pivoting movement of the lid. The hand movements can also be reversed, of course, i.e., be performed by the other hand, respectively.

With another closure device, the second closing means is situated between the first and third closing means, and the third closing means is implemented like the first one (i.e., it can be opened by application of force to the frame section). In this case, the closure device is opened in the preferred manner by the user pressing on the respective frame section of the first closing means by using one finger on one hand, and at the same time pressing on the lid section assigned to the second and third closing means by using the thumb and index finger of the other hand, and carrying out the pivoting movement of the lid. The other hand also holds the closure device securely.

To close the closure device, the lid is pressed onto the frame, namely with enough force to latch the individual closing means.

The first closing means can be opened by direct application of force to the respective frame section. It is preferable for the respective frame section to comprise a corresponding pressure surface. The second closing means can be opened by direct application of force to the respective lid section. It is preferable for the respective lid section to comprise a corresponding pressure surface. The pressure surface(s) is/are understood in this sense to refer to one or more surfaces for application of force. The pressure surfaces are configured in such a way that they can each be activated with one finger. It is preferable to configure the second closing means in such a way that the lid is transferred from the closed position to the open position while the user's finger(s) is/are continuously and uninterruptedly in contact with the pressure surface(s).

The closing means are configured so that the direct application of force to bring a closing means into the open position and/or hold it there preferably occurs within a force value range between 0.1N and 15N, preferably between 1N and 5N. This value range comprises relatively weak forces, which the user can apply conveniently in order to use the closure device.

It is preferable for the lid section belonging to the first closing means and the corresponding frame section to each form a latching closure. Additionally or alternatively, it is advisable for the lid section belonging to the second closing means and the corresponding frame section to each form a latching closure. Latching closures are familiar to those skilled in the art and are also frequently used in commercial products because of the simple handling.

### Position of the Pressure Surfaces on the Lid Section

In one variant of the invention, at least one lid section assigned to a closing means has a pressure surface, which is set back from an exterior wall region of the frame in the direction of the opening. It is preferable for the pressure surface of the second closing means to be set back with respect to the exterior wall region of the lid. In one embodiment of the invention, the pressure surfaces of the closing means, which can be opened by direct application of force to the respective lid section, are set back with respect to the exterior wall region of the frame. An increased level of safety of the closure device is achieved with (a) set-back pressure surface(s) because the closing means cannot be activated without a more detailed positioning of the application of force.

In addition, it is preferable for the pressure surface of the first closing means to be coplanar with the exterior wall region of the frame. “Coplanar” in this case means that the pressure surface and the exterior wall region of the frame are arranged geometrically in the same plane. An increased level of safety of the closure device is achieved with this combination of the pressure surface of the first closing means, which is coplanar with the frame, and the pressure surface of the second closing means, which is set back with respect to the lid.

In addition to the aforementioned variants of the position of the pressure surfaces on a lid, it is preferable for the pressure surfaces and the lid to be designed in one piece. The integral design of the pressure surface and the lid reduces the number of components as well as the number of manufacturing steps. An alternative variant, although less preferred, is to design the pressure surface as a separate part that is attached to the lid during the manufacture of the closure device.

### Position of the Pressure Surfaces on the Frame Section

In one variant of the invention, at least one frame section assigned to a closing means comprises a pressure surface that is coplanar with an exterior wall region of the frame. “Coplanar” in this case means that the pressure surface and the exterior wall region of the frame are arranged geometrically in the same plane.

In addition to the embodiment mentioned above, it is preferable for the pressure surfaces and the frame to be designed in one piece. The integral design of the pressure surface and the frame reduces the number of components and the number of manufacturing steps. An alternative, but less preferred variant is to design the pressure surface in one piece, which is attached to the lid during the manufacture of the closure design.

### Embodiment of the Pressure Surface

According to one advantageous embodiment of the closure device, at least one pressure surface comprises a surface that is suitable for being subjected to a force applied by a hand, preferably a finger. All pressure surfaces are preferably designed in this way.

In one first embodiment of the invention, the pressure surface is arranged perpendicular to the lid surface. In another embodiment of the invention, the pressure surface is a lever handle, which protrudes out of the lid, preferably out of the upper edge of the lid.

According to another embodiment of the closure device, at least one pressure surface comprises an auxiliary means for opening. The auxiliary means may be elevations and/or indentations, for example. The auxiliary means permit better adhesion properties with the user's finger or hand due to a suitable haptic surface design. According to a preferred shape, the auxiliary means are designed as ribs.

In addition, marks indicating to a user which closing means can be used to tilt up the lid and thus open it are provided on the closure device. Such suitable marks are symbols such as a triangle or an arrow indicating a direction of movement, for example.

### Tamper-Proof Closure

It can be provided that at least one of the closing means comprises a tamper-proof closure. In addition, it is preferable for this closing means to comprise a set-back pressure surface, so that the tamper-proof closure is coplanar with the exterior wall region of the frame or the lid, preferably the lid, i.e., it is in the same plane. The tamper-proof closure is configured so that it must be at least partially broken off, preferably completely separated from the closure device, before the lid is opened for the first time.

### Third and Additional Closing Means

The embodiments and configurations of the first and second closing means cited in the description also relate to an optional third or additional closing means, if present. In this respect, a third and an additional closing means may have the same embodiment as the first closing means. The third closing means preferably has the structural shape of the second closing means. By providing a third closing means, a higher level of closing reliability of the closure device is achieved in general.

### Lid and Frame

The lid is pivotably connected to the frame via a pivot axis arranged on one side of the frame. The lid and the frame may advantageously be designed as an integral component, preferably made of plastic.

Typical known variants of pivot embodiments, which are also known in common commercial household products, for example, may be used as a pivotable arrangement of the lid with the frame. An elastically deformable plastic connection, which is manufactured in one piece (and simultaneously) with the lid and the frame, is preferred.

Alternatively, the lid and the frame may be designed as independent parts, preferably as two plastic parts. In one embodiment of the invention, the connection between the lid and the frame on the pivot axis is such that the connected parts cannot be separated from one another without a substantial application of force that can lead to deformation of the parts. The lid and the frame are thus inseparably connected to the pivot axis under normal use conditions. The lid and the frame may also be embodied as an integral component, preferably made of plastic. In addition, the frame may be separably or inseparably connected to the respective container. The frame is preferably attachably coupled to a container. In an alternative embodiment, the frame is part of a container and is integrally molded onto the container in one piece, wherein the frame and the container are preferably made of plastic.

Any suitable plastic material may be used as the plastic. Plastics selected from the group of polyolefins are preferred. Particularly preferred are the following plastics from the class of polypropylenes; polyethylenes; blends containing polypropylene; blends containing polyethylene; copolymers and/or random copolymers containing polypropylene; copolymers containing polyethylene.

The container is preferably transparent and may comprise additional parts, such as a label, for example. The container is preferably produced from polyethylene terephthalate (PET), polypropylene (PP) or their derivative-based plastics.

The frame preferably contains plastic from the polypropylene class. The lid preferably contains plastic from the polypropylene class.

The lid is preferably colored. If the lid and the frame are in one piece, it is also preferable for the lid and the frame to be manufactured produced from the same colored plastic.

### Arrangement of the Closing Means

In one embodiment of the invention, the proximal distance between two closing means, measured on the circumference of the frame, is less than 20 cm, more preferably less than 15 cm. For example, the proximal distance between the outermost two closing means on an essentially rectangular frame, on which two or three closing means are provided on the same side of the frame, is less than 15 cm. In one embodiment with three closing means, the greatest proximal distance between the two outermost closing means is less than 15 cm, preferably less than 10 cm.

When opening a closing means and with a corresponding movement of the lid, a force is applied to a second/additional closing means. With the distance restriction described between the closing means, the lever effect between these is also limited. Due to the restriction on the lever effect, this ensures that the second/additional closing means cannot be easily deformed or destroyed. The closure device thus remains closed as long as all the closing means have not been opened properly.

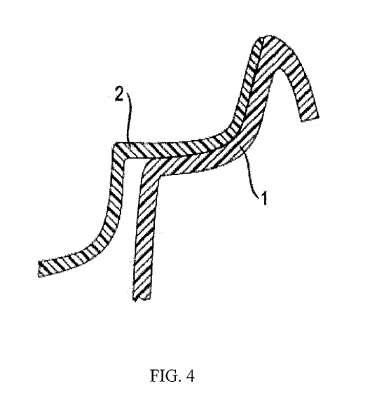

This design especially preferably includes a lid that is flush with the frame, so that the edge of the lid cannot be touched to open it. See also FIG. 4 in this regard. It is preferable for the closure device to be configured so that the edge of the lid is arranged beneath the top edge of the frame in the closed position of the closure device.

The pivot axis here defines a first side of the closure device. The closing means are preferably arranged on a side of the arrangement opposite the pivot axis. On the other hand, an arrangement of the individual closing means “across the corner” of the frame is also possible, but not preferred. In a preferred embodiment, a closing means is arranged centrally on a side of the arrangement opposite the pivot axis. In an alternative embodiment, both closing means, i.e., the first and second closing means, are arranged at least mostly on one half of one side of the arrangement of the frame. This is particularly preferred if the side of the arrangement is the side opposite the pivot axis.

In general, the preferred application of the container is for detergents and cleaning agents, so it is preferable for the container to comprise detergents and/or cleaning agents, in particular apportioned detergents and/or cleaning agents, at least one lateral dimension of which is equal to or greater than 31.7 mm, more preferably not fitting into a cylinder according to ISO Standard 8124-1 (second edition, date Mar. 15, 2009), 5.2 and therefore passing the “small parts test.”

### Figures

The invention will now be explained in greater detail on the following figures, which show only exemplary embodiments. They show:

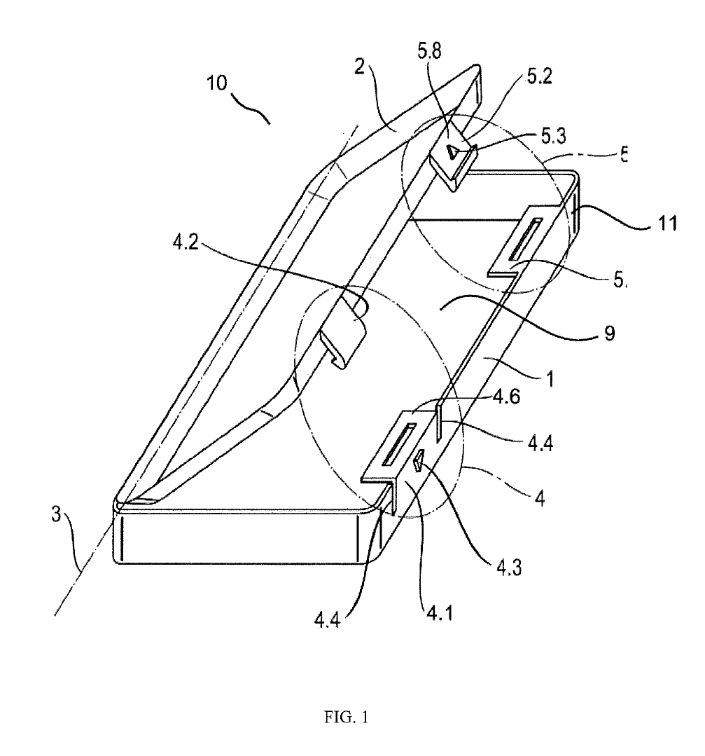

FIG. 1 a closure device according to the invention with a lid and a frame having a first and a second closing means in a perspective basic diagram;

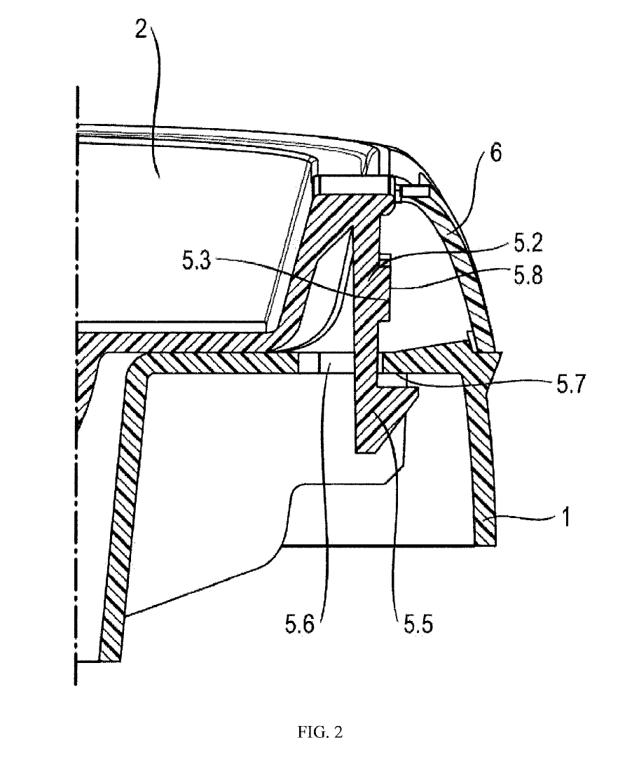

FIG. 2 a second closing means of a closure device according to the invention in a sectional diagram;

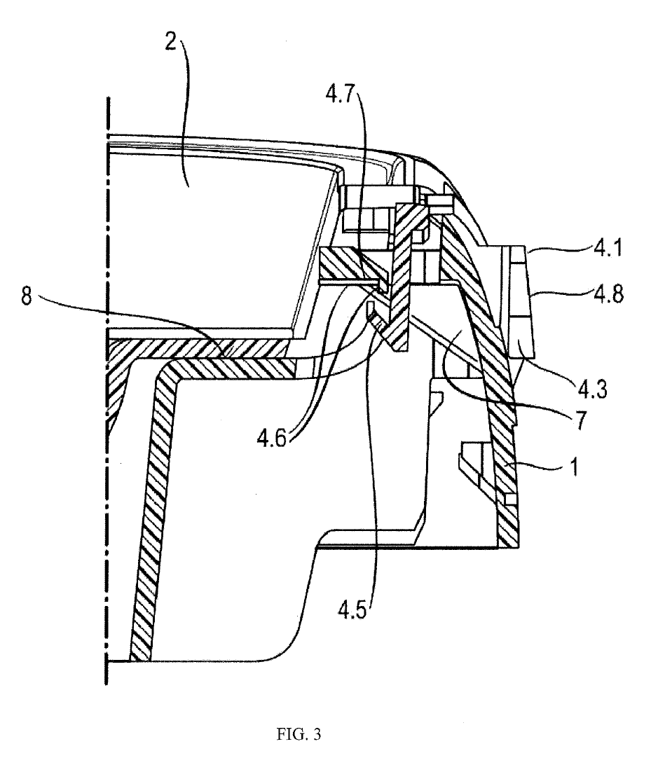

FIG. 3 a first closing means of a closure device according to the invention in a sectional diagram;

FIG. 4 a section of the closure device with a lid and a frame in a region without closing means in a sectional diagram.

Reference numerals are used in the figures below. These serve to facilitate an understanding of the invention but are not restrictive.

FIG. 1 shows an embodiment according to the invention of the closure device 10. According to FIG. 1, a lid 2 is arranged pivotably on a frame 1 of the closure device 10, thereby defining a pivot axis 3. The closure device 10 comprises a first closing means 4 and a second closing means 5 (4, 5). The closing means 4, 5 basically keep the lid in the closed position (not shown). However, FIG. 1 shows the open position of the closure device 10.

The first closing means 4 comprises a respective frame section 4.1 and a respective lid section 4.2. The second closing means 5 comprises a respective frame section 5.1 and a respective lid section 5.2.

The first closing means 4 can be opened by direct application of force to the respective frame section 4.1, which preferably comprises a pressure surface 4.8. The second closing means 5 can be opened in turn by direct application of force to the respective lid section 5.2, which preferably comprises a pressure surface 5.8. To convert the closure device from a closed lid position into an open lid position, all the closing means 4, 5 must be open, i.e., both the first and the second closing means 4, 5.

To open the closure device 10, the user presses, preferably with his left thumb, on the frame section 4.1 assigned to the first closing means 4 and at the same time presses with his right thumb on the lid section 5.2 assigned to the second closing means 5. The other fingers on both hands can secure the closure device 10 in its position. The pivoting movement of the lid to open it is then performed with the right hand. Similarly with the opposite arrangement of the first closing means 4 and the second closing means 5 (4, 5), the fingers are positioned differently, and the pivoting movement of the lid is then performed with the left hand

The frame section 4.1 of the first closing means 4 may also comprise wall indentations 4.4 to reduce the required application of force to the pressure surface 4.8 in comparison with the section without wall indentations. The wall indentations 4.4 are preferably formed on both sides of a pressure surface 4.8.

FIG. 1 shows a simplified schematic diagram of the closure device. The latching slots 4.6, 5.6 are preferably arranged beneath an upper edge of the frame 1.

FIG. 2 shows a cross section of a closure device according to the invention through a second closing means 5. The second closing means 5 comprises a lid section 5.2 of the lid 2 and a frame section 5.1 of the frame 1. The lid section 5.2 comprises a pressure surface 5.8 for application of force to open the second closing means 5. The pressure surface 5.8 in this case is set back with respect to the exterior wall region of the frame 1. A tamper-proof closure 6 is coplanar with the exterior wall region of the frame 1. In this case, the second closing means 5 is a latching closure having a latching slot 4.6, 5.6 and a latching part 4.5, 5.5.

FIG. 3 shows a cross section through a closure device according to the invention through a first closing means 4. The first closing means 4 comprises a lid section 4.2 of the lid 2 and a frame section 4.1 of the frame 1. The frame section 4.1 comprises a pressure surface 4.8 for application of force to open the first closing means 4. The pressure surface 4.8 in this case is designed to be elevated in comparison with the exterior wall of the frame 1. Alternatively, the pressure surface may be designed to be coplanar with the exterior wall of the frame; a coplanar pressure surface is not strongly emphasized visually from the former. The coplanar pressure surface increases the closing reliability of the closure device. The user must first recognize the closing means clearly in order to intentionally open the closure device in another step.

Such closing means in the figures are each designed as a latching closure. Latching closures may be used in any way in the other embodiments of the invention. A latching closure comprises a latching slot 4.6, 5.6 and the latching part 4.5, 5.5, wherein the latching part 4.5, 5.5 is attached to a spring. The spring holds the latching part 4.5, 5.5 in the resting position. In the closed position, the latching part 4.5, 5.5 latches with a latching edge 4.7, 5.7 in a form-fitting manner, so that the latching closure therefore cannot be opened. Through the tension on the spring, the latching part 4.5, 5.5 can be brought into an unlatched position, in which the latching part 4.5, 5.5 fits through the latching edge 4.7, 5.7. The latching closure can be brought from this unlatched position into an open position. To close it, the latching part 4.5, 5.5 is moved out of an open position and onto the latching edge 4.7, 5.7. This shape of the latching part 4.5, 5.5 (an inclined plane, for example) is such that application of force to the latching part 4.5, 5.5 in the direction of the latching edge 4.7, 5.7 deforms the spring elastically in such a way that the latching part 4.5, 5.5 can pass the latching edge 4.7, 5.7.

The latching edge 4.7, 5.7 is preferably part of a latching slot 4.6, 5.6.

In one embodiment of the invention, the second closing means 5 comprises at least two latching parts, especially preferably three latching parts. The latching parts cooperate with the latching edge 5.7.

FIG. 4 shows a diagram of a cross section through the lid and the frame. One lid edge ends flush with the frame, and preferably beneath a top edge of the frame (may be more strongly pronounced than indicated in the figure). It is therefore difficult to apply force to the lid in order to open it because there is no surface for the application of force.

### REFERENCE NUMERALS

1 Frame
2 Lid
3 Pivot axis
4 First closing means
5 Second closing means
6 Optional tamper-proof closure
7 Reinforcement
8 Supporting surface
9 Opening
10 Closure device
11 Side of arrangement
4.1 Frame section of the first closing means
4.2 Lid section of the first closing means
4.3 Optional symbol for the first closing means
4.4 Wall indentation in the first closing means
4.5 Latching part of the first closing means
4.6 Latching slot of the first closing means
4.7 Latching edge of the first closing means
4.8 Pressure surface of the first closing means on the frame region
5.1 Frame section of the second closing means
5.2 Lid section of the second closing means
5.3 Optional symbol of the second closing means
5.5 Latching part of the second closing means
5.6 Latching slot of the second closing means
5.7 Latching edge of the second closing means
5.8 Pressure surface of the second closing means on the lid region

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. Container for detergents and cleaning agents comprising a closure device (10), the closure device (10) comprising:
a frame (1), which defines an opening (9), and a lid (2), which covers the opening (9) and is coupled to the frame so as to be pivotable about a pivot axis (3), which is arranged on one side of the frame (1), to change from a closed position, in which the lid (2) closes the opening (9), into an open position, in which the lid (2) is at a distance from the frame (1) and thus exposes the opening (9),
at least one first and one second closing means (4, 5), each formed from a lid section and a respective frame section, to hold the lid in the closed position on the frame (1), characterized in that:
the first closing means (4) can be opened by direct application of force to the respective frame section;
the second closing means (5) can be opened by direct application of force to the respective lid section; and
the first and the second closing means (4, 5) are spaced a distance apart from one another.

2. Container according to claim 1, characterized in that a third closing means is provided in the closure device (10), the means being openable by direct application of force to the respective lid section.

3. Container according to claim 1, characterized in that a third closing means is provided in the closure device (10), the means being openable by direct application of force to the respective frame section.

4. Container according to claim 2, characterized in that the lid section (5.2) assigned to the second closing means (5) and/or the third closing means has a pressure surface (5.8) for application of force, the surface being set back from an exterior wall region of the frame (1) in the direction of the opening (9).

5. Container according to claim 3, characterized in that the frame section (4.1) assigned to the first closing means (4) and/or the third closing means has a pressure surface (4.8) for application of force, the surface being coplanar with an exterior wall region of the frame (1).

6. Container according to claim 1, characterized in that the first and the second closing means (4, 5) are arranged on one side (11) of the arrangement of the closure device.

7. Container according to claim 6, characterized in that the third closing means additionally is arranged on the same side (11) of the arrangement on which the first and the second closing means (4, 5) are also arranged.

8. Container according to claim 6, characterized in that the side (11) of the arrangement is arranged opposite the pivot axis (3).

9. Container according to claim 1, characterized in that two closing means (4, 5) are each arranged on respective frame sections or lid sections of the closure device (10) at a distance of less than 20 cm.

10. Container according to claim 1, characterized in that the distance between the first and the second closing means (4, 5) of the closure device (10) is less than 15 cm.

11. Container according to claim 1, characterized in that the distance between the first and the third closing means of the closure device (10) is less than 15 cm.

12. Container according to claim 1, characterized in that at least one of the closing means (4, 5) of the closure device (10) comprises a tamper-proof closure.

13. Container according to claim 1, characterized in that the lid (2) and the frame (1) of the closure device (10) are designed as an integral part.

14. Container according to claim 1, characterized in that the lid (2) and the frame (1) of the closure device (10) are designed as independent parts.

15. Container according to claim 1, characterized in that the frame (1) is coupled attachably to the container.
